(19) United States
(12) Patent Application Publication
(10) Pub. No.: US 2026/0254115 A1
(43) Pub. Date: Aug. 27, 2026

(54) ANTENNA ASSEMBLY AND ELECTRONIC DEVICE

(71) Applicant: HUAWEI TECHNOLOGIES CO., LTD., Shenzhen (CN)

(72) Inventors: Zongxin Yi, Dongguan (CN); Haibing Xu, Shanghai (CN); Xiaoxiao Mou, Shanghai (CN)

(21) Appl. No.: 19/650,597

(22) Filed: Apr. 17, 2026

Related U.S. Application Data
(63) Continuation of application No. PCT/CN2024/099988, filed on Jun. 19, 2024.

(30) Foreign Application Priority Data
Oct. 20, 2023 (CN) 202311375750.2

(51) Int. Cl. H01Q 5/28; H01Q 5/371

(52) U.S. Cl. CPC H01Q 5/28; H01Q 5/371

(57) ABSTRACT

This application provides an antenna assembly and an electronic device. The antenna assembly (20) includes an insulating support body (21); and at least two antennas (22). The at least two antennas (22) are each fixed to the insulating support body (21), and a gap is provided between any two antennas (22). According to this application, a quantity of feed points of the antenna assembly can be the same as a quantity of antennas.

### CROSS-REFERENCE TO RELATED APPLICATIONS

This application is a continuation of International Application No. PCT/CN2024/099988, filed on June 19, 2024, which claims priority to Chinese Patent Application No.202311375750.2, filed on October 20, 2023. The disclosures of the aforementioned applications are hereby incorporated by reference in their entireties.

### BACKGROUND

A router is usually provided with an antenna assembly, which enables transmission and reception of signals. The antenna assembly usually includes two 2G antennas and two 5G antennas.

In a related technology, the antenna assembly is produced by cutting, bending, and other processes applied to a complete sheet metal, where both the two 2G antennas and the two 5G antennas are bent portions formed by bending the sheet metal. Because both the 2G antennas and the 5G antennas are made of the same sheet metal, the two 2G antennas are functionally dependent on each other, and the two 5G antennas are functionally dependent on each other. Therefore, the two 2G antennas can provide only one feed point for the antenna assembly, and the two 5G antennas can also provide only one feed point for the antenna assembly, so that the antenna assembly has two feed points. In other words, a quantity of feed points of the antenna assembly is different from a quantity of antennas of the antenna assembly.

### SUMMARY

To resolve the above-described technical problem, this application provides an antenna assembly and an electronic device, enabling a quantity of feed points of the antenna assembly to be the same as a quantity of antennas.

According to a first aspect of this application, an antenna assembly is provided. The antenna assembly includes an insulating support body and at least two antennas. The at least two antennas are each fixed to the insulating support body, and a gap is provided between any two antennas. That is, the at least two antennas are fixed to the insulating support body in a distributed manner. In this way, each antenna is relatively functionally independent, and each antenna can provide one feed point for the antenna assembly. Therefore, a quantity of feed points of the antenna assembly is the same as a quantity of antennas.

For the quantity of antennas, in a possible embodiment, the antenna assembly includes four antennas, namely, a first antenna, a second antenna, a third antenna, and a fourth antenna. The first antenna, the second antenna, the third antenna, and the fourth antenna provide four feed points for the antenna assembly. That is, the antenna assembly has four feed points. In this way, the antenna assembly can achieve a four-feed function. An electronic device such as a router usually includes four front-end modules, which are respectively two 2G front-end modules and two 5G front-end modules. Each front-end module is electrically connected to the antenna assembly via a feeder. Compared with an antenna assembly having two feed points, when the antenna assembly in this application has four feed points, the quantity of feed points is the same as the quantity of front-end modules, and each front-end module can be connected to a corresponding feed point via a feeder, without requiring a duplexer to combine signals, thereby reducing costs of the electronic device.

In another possible embodiment, the antenna assembly may include two antennas, and the antenna assembly has two feed points. Alternatively, the antenna assembly may include three antennas, and the antenna assembly has three feed points. Alternatively, the antenna assembly includes five antennas, and the antenna assembly has five feed points. Certainly, the antenna assembly may also include a larger number of antennas.

For operating bands of the antennas, in a possible embodiment, an operating band of the first antenna may be the same as an operating band of the second antenna, and an operating band of the third antenna may be the same as an operating band of the fourth antenna, where the operating band of the third antenna and the operating band of the fourth antenna are both lower than the operating band of the first antenna and the operating band of the second antenna. In an example, the first antenna and the second antenna are both 5G antennas, and the third antenna and the fourth antenna are both 2G antennas. In another example, the first antenna and the second antenna are both 2G antennas, and the third antenna and the fourth antenna are both 5G antennas. In this way, the antenna assembly includes two operating bands, so that the antenna assembly can achieve a dual-band four-feed function.

Based on this, polarization directions of the first antenna and the second antenna are different. In this way, the antenna assembly can achieve a dual-polarization function. In other words, the antenna assembly in this application can achieve a dual-band four-feed dual-polarization function, thereby improving a throughput of the antenna assembly.

In another possible embodiment, operating bands of the first antenna, the second antenna, and the third antenna are the same, and operating bands of the fourth antenna and the first antenna are different. For example, the first antenna, the second antenna, and the third antenna are all 5G antennas, and the fourth antenna is a 2G antenna; or the first antenna, the second antenna, and the third antenna are all 2G antennas, and the fourth antenna is a 5G antenna.

For the structure of the insulating support body, in a possible embodiment, the insulating support body includes a first support plate and a second support plate fixed to the first support plate, and there is an included angle between the second support plate and the first support plate. In an example, an end portion of the second support plate is fixedly connected to an end portion of the first support plate. In this way, the insulating support body may form an "L"-shaped structure. In another example, the second support plate is fixed to the middle of the first support plate. In this way, the insulating support body may form a "T"-shaped structure. Compared with the flat plate-like insulating support body, the insulating support body in this application is stronger.

The at least two antennas may be each fixed to the insulating support body. One part of the at least two antennas is fixed to the first support plate, and the other part of the antennas is fixed to the second support plate. In this way, a smaller number of antennas are fixed to the first support plate or the second support plate, so that a distance between the antennas fixed to a same support plate can be increased, and signal interference between the antennas fixed to the same support plate can be reduced, thereby improving antenna isolation.

For example, the first antenna, the second antenna, the third antenna, and the fourth antenna may all have a plate-like structure. The first antenna and the second antenna are fixed to the first support plate, and the third antenna and the fourth antenna are fixed to the second support plate. Certainly, in other embodiments, the first antenna and the third antenna are fixed to the first support plate, and the second antenna and the fourth antenna are fixed to the second support plate.

In addition, the antenna assembly further includes a decoupling portion. The decoupling portion may be fixed to the insulating support body, and the decoupling portion is located between the third antenna and the fourth antenna. In this way, the decoupling portion can reduce coupling between a signal of the third antenna and a signal of the fourth antenna, thereby further improving antenna isolation.

Further, the second support plate includes a first surface, and the third antenna, the decoupling portion, and the fourth antenna are spaced apart and fixed to the first surface. In this way, there is a spacing between the third antenna and the decoupling portion, and there is a spacing between the decoupling portion and the fourth antenna, so that a decoupling effect of the decoupling portion between the third antenna and the fourth antenna can be further improved.

For the structure of the insulating support body, in another possible embodiment, the insulating support body includes a first support plate, and a second support plate and a third support plate that are fixed to the first support plate. The second support plate and the third support plate are disposed opposite to each other. The second support plate and the third support plate are fixed to a same plate surface of the first support plate. In an example, the second support plate and the third support plate are fixed to two ends of the same plate surface of the first support plate. In this case, the insulating support body may form an approximate "U"-shaped structure. In another example, the second support plate and the third support plate are fixed to the same plate surface of the first support plate, and are at a specific distance from both ends of the plate surface. In this way, the first support plate, the second support plate, and the third support plate may form a frame structure, so that the insulating support body is stronger.

Based on this, the third antenna and the fourth antenna may use the foregoing plate-like structure. Alternatively, the third antenna and the fourth antenna may be of the "L"-shaped structure. For example, the third antenna and the fourth antenna may both include a first plate and a second plate connected to each other and forming an included angle. The respective first plates of the third antenna and the fourth antenna are both fixed to the first support plate, and the respective second plates of the third antenna and the fourth antenna are both fixed to the second support plate. In this way, the third antenna is fixedly connected to the two support plates of the insulating support body, resulting in a stronger connection between the third antenna and the insulating support body. The fourth antenna is also fixedly connected to the two support plates of the insulating support body, resulting in a stronger connection between the fourth antenna and the insulating support body. On this basis, the decoupling portion is fixed to the first support plate or the second support plate, and is located between the third antenna and the fourth antenna. In this way, the decoupling portion can still improve antenna isolation.

For a connection relationship between the insulating support body and each of the third antenna and the fourth antenna, in an example, a through hole is provided at an end of the first support plate close to the second support plate, and the respective first plates of the third antenna and the fourth antenna are both fixed to a surface of the first support plate that faces away from the second support plate. One part of both the respective second plates of the third antenna and the fourth antenna is located within the through hole, and the other part thereof extends beyond the through hole. In addition, the respective second plates of the third antenna and the fourth antenna are fixed to a surface of the second support plate that faces the third support plate. In this way, a part of the third antenna is fixed to the second support plate in an embedded manner, resulting in a stronger connection between the third antenna and the second support plate, that is, a stronger connection between the third antenna and the insulating support body. Similarly, this can also result in a stronger connection between the fourth antenna and the insulating support body.

Further, the respective first plates of the third antenna and the fourth antenna are both fixed to a surface of the first support plate that faces away from the second support plate, and the respective second plates of the third antenna and the fourth antenna are both fixed to a surface of the second support plate that faces away from the third support plate. Herein, an inner side and an outer side of the insulating support body may be defined. An accommodation space may be formed between the second support plate and the third support plate of the insulating support body. The accommodation space may be on the inner side of the insulating support body, and a side opposite to the inner side is the outer side. In other words, the third antenna and the fourth antenna are both fixed to the outer side of the insulating support body.

The antenna assembly according to this application may be manufactured by using the following two methods:

In a first method, the antennas may be first manufactured by stamping molding, machining, and the like. The antennas are placed inside a mold, and injection molding is performed within the mold to form the insulating support body, thereby producing the antenna assembly. The insulating support body may be made of an insulating material such as plastic, and the antennas are connected to the insulating support body once injection molding is completed. Because the third antenna and the fourth antenna are both fixed to the outer side of the insulating support body, during the placement of the third antenna and the fourth antenna inside the mold before injection molding, the third antenna and the fourth antenna may both be attached closely to the inner wall of the mold for placement, so that the third antenna and the fourth antenna can be conveniently secured in the mold.

In a second method, the insulating support body may be first manufactured by injection molding. Areas on the insulating support body in which the antennas are disposed are metallized to form the antennas, thereby producing the antenna assembly. When the third antenna and the fourth antenna are both fixed to the outer side of the insulating support body, it is convenient to manufacture the third antenna and the fourth antenna through metallization.

According to a second aspect of this application, an electronic device is further provided. The electronic device includes a circuit board and the antenna assembly according to any one of the foregoing embodiments, where the antenna assembly is fixed to the circuit board. The electronic device can achieve all the effects of the antenna assembly.

### BRIEF DESCRIPTION OF DRAWINGS

To describe the technical solutions in embodiments of this application more clearly, the following briefly describes the accompanying drawings used for describing embodiments of this application. It is clear that, the accompanying drawings in the following description show merely some embodiments of this application, and a person of ordinary skill in the art may still derive other drawings from these accompanying drawings without creative efforts.

FIG. 1 is a circuit diagram of an electronic device in a related technology;

FIG. 2 is a diagram, from a perspective, of a structure of an antenna assembly according to a first embodiment of this application;

FIG. 3 is a side view of the antenna assembly shown in FIG. 2;

FIG. 4 is a diagram of a structure of an antenna assembly according to a second embodiment of this application;

FIG. 5 is another diagram of a structure of an insulating support body;

FIG. 6 is a diagram, from another perspective, of the antenna assembly shown in FIG. 2;

FIG. 7 is a circuit diagram of an electronic device using the antenna assembly shown in FIG. 2;

FIG. 8 is a diagram, from a perspective, of a structure of connection between the antenna assembly of an embodiment shown in FIG. 2 and a circuit board;

FIG. 9 is a diagram, from another perspective, of a structure of connection between the antenna assembly of an embodiment shown in FIG. 2 and a circuit board;

FIG. 10 is a diagram of a structure of an antenna assembly according to a third embodiment of this application;

FIG. 11 is still another diagram of a structure of an insulating support body;

FIG. 12 is a diagram of a first structure of connection between the antenna assembly shown in FIG. 10 and a circuit board;

FIG. 13 is a diagram of a second structure of connection between the antenna assembly shown in FIG. 10 and a circuit board; and

FIG. 14 is a diagram of a structure of the antenna assembly according to the third embodiment.

Reference numerals: 1. electronic device; 11. feeder; 12. filter; 13. 2G FEM; 14. 5G FEM; 15. duplexer; 16. switching converter; 20. antenna assembly; 21. insulating support body; 211. first support plate; 2111. plate surface; 2112. first end; 2113. second end; 212. second support plate; 2121. first surface; 213. third support plate; 214. accommodation space; 22. antenna; 221. first antenna; 222. second antenna; 223. third antenna; 2231. first plate; 2232. second plate; 224. fourth antenna; 23. decoupling portion; and 30. circuit board.

### DESCRIPTION OF EMBODIMENTS

The following clearly and describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application without creative efforts shall fall within the protection scope of this application.

The term "and/or" in this specification describes only an association relationship between associated objects and indicates that three relationships may exist. For example, A and/or B may indicate the following three cases: Only A exists, both A and B exist, and only B exists, where A and B may be singular or plural. The character "/" generally indicates an "or" relationship between the associated objects. "At least one (item)" means one or more, and "a plurality of" means two or more. "At least one of the following" or a similar expression thereof indicates any combination of these items, including a single item or any combination of plural items. For example, at least one of a, b, or c may indicate a, b, c, "a and b", "a and c", "b and c", or "a, b, and c", where a, b, and c may be singular or plural.

In the specification and claims in embodiments of this application, the terms "first", "second", and so on are intended to distinguish between different objects but do not indicate a particular order of the objects. For example, a first target object, a second target object, and the like are used for distinguishing between different target objects, but are not used for describing a specific order of the target objects.

The terms such as "connection", "connected", and the like are used for indicating interworking or mutual interaction between different components, and may include a direct connection or an indirect connection via another component. In addition, the terms "include", "have", and any variant thereof are intended to cover non-exclusive inclusion, for example, include a series of steps or units. For example, a method, system, product, or device is not necessarily limited to those steps or units expressly listed, but may include other steps or units not expressly listed or inherent to such a process, method, product, or device. "On", "below", "left", "right", and the like are used only relative to the orientation of the components in the accompanying drawings. These directional terms are relative concepts, are used for relative descriptions and clarifications, and may change accordingly as positions at which the components in the accompanying drawings are placed change.

In addition, in embodiments of this application, the word "exemplary" or "for example" is used to represent giving an example, an illustration, or a description. Any embodiment or design scheme described as an "example" or "for example" in embodiments of this application should not be explained as being more preferred or having more advantages than another embodiment or design scheme. To be precise, use of the term like "example" or "for example" is intended to present a relative concept in a specific manner.

In descriptions of embodiments of this application, unless otherwise stated, "plurality of" means two or more than two. For example, a plurality of processing units mean two or more processing units, and a plurality of systems mean two or more systems.

For ease of understanding the antenna assembly in this application, technical terms are first explained.

Antenna: an electronic device used to transmit or receive radio waves or electromagnetic waves.

Antenna throughput: an amount of data successfully transmitted over a network, a device, a port, a virtual circuit, or another facility in a unit of time.

Antenna isolation: a ratio of power of a signal transmitted by one antenna to power of the signal received by another antenna.

Antenna feed point: a location on an antenna that a feeder connects to send a signal transmitted from the antenna to the feeder and send a signal transmitted from the feeder to the antenna.

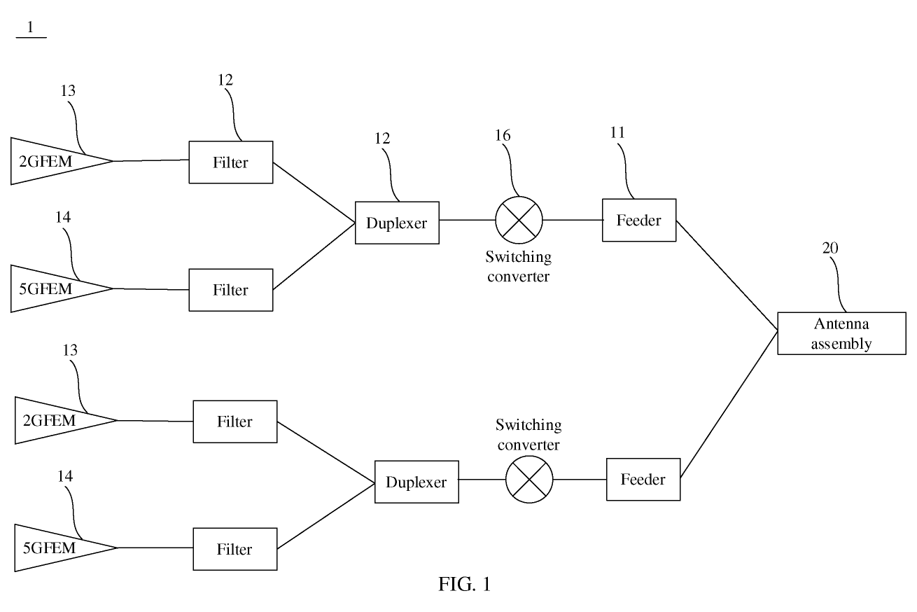

As shown in FIG. 1, an electronic device 1 usually includes an antenna assembly 20. The antenna assembly 20 is configured to transmit and receive signals. Because 5G communication has advantages such as a large communication capacity and a strong signal, the antenna assembly 20 usually includes a 5G antenna. However, wall penetration performance of a 5G signal is relatively poor. Therefore, to improve wall penetration performance of a signal received or transmitted by the electronic device 1, the antenna assembly 20 further includes a 2G antenna. The electronic device 1 herein may be a router, a mobile phone, a tablet computer, a wearable device, an augmented reality (AR) device, a notebook computer, an ultra-mobile personal computer (PC), or the like.

Currently, the electronic device 1 requires a dual-band four-feed function. Therefore, the antenna assembly 20 includes two 2G antennas and two 5G antennas. In a related technology, the antenna assembly 20 is produced by cutting, bending, and other processes applied to a complete sheet metal, where both the two 2G antennas and the two 5G antennas are bent portions formed by bending the sheet metal. Operating bands of the 2G antennas and the 5G antennas are different; that is, the antenna assembly 20 has two operating bands. In addition, because both the 2G antennas and the 5G antennas are made of the same sheet metal, the two 2G antennas are functionally dependent on each other, and the two 5G antennas are functionally dependent on each other. Therefore, the two 2G antennas can provide only one feed point for the antenna assembly 20, and the two 5G antennas can also provide only one feed point for the antenna assembly 20, so that the antenna assembly 20 has two feed points. In this way, the antenna assembly 20 can achieve a dual-band dual-feed function. It can be learned that, in the related technology, a quantity of feed points of the antenna assembly 20 is different from a quantity of antennas of the antenna assembly 20.

To achieve function integration, as shown in FIG. 1, the electronic device 1 usually includes two 2G front-end modules (FEMs) 13, two 5G FEMs 14, and four filters 12. The two 2G FEMs 13 and the two 5G FEMs 14 are electrically connected to the filters 12, respectively. Because the antenna assembly 20 has two feed points, the electronic device 1 includes two feeders 11. In this case, a quantity of feeders 11 is different from a quantity of filters 12. Therefore, duplexers 15 need to be added to the links. The duplexers 15 each have two input ports, where respective output ports of two filters 12 are electrically connected to two input ports of one duplexer 15, respectively, and an output port of the duplexer 15 is electrically connected to one feed point of the antenna assembly 20 via a feeder 11. This will result in an increased cost of the electronic device 1.

If the links between the FEMs and the antenna assembly 20 are active links, as shown in FIG. 1, the electronic device 1 further includes two switching converters 16. One end of each switching converter 16 is electrically connected to the output port of the duplexer 15, and the other end of the switching converter 16 is electrically connected to the feeder 11.

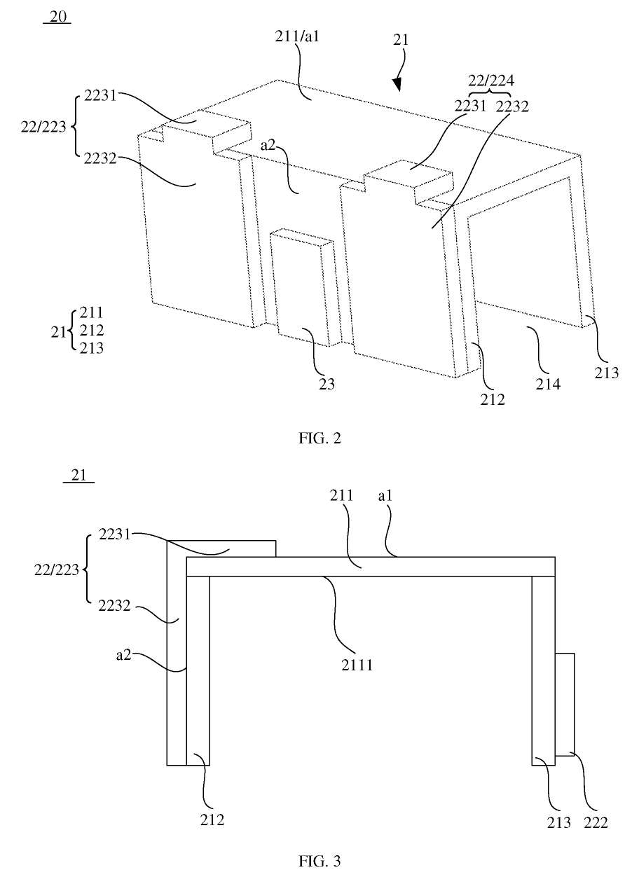

In view of this, as shown in FIG. 2, an embodiment of this application provides an antenna assembly 20. The antenna assembly 20 includes an insulating support body 21 and at least two antennas 22. The at least two antennas 22 are each fixed to the insulating support body 21, and a gap is provided between any two antennas 22. That is, the at least two antennas 22 are fixed to the insulating support body 21 in a distributed manner. In this way, each antenna 22 is relatively functionally independent, and each antenna 22 can provide one feed point for the antenna assembly 20. Therefore, a quantity of feed points of the antenna assembly 20 is the same as a quantity of antennas 22.

As shown in FIG. 2, the insulating support body 21 includes a first support plate 211, and a second support plate 212 and a third support plate 213 that are fixed to the first support plate 211. The second support plate 212 and the third support plate 213 are disposed opposite to each other. In this embodiment, the first support plate 211, the second support plate 212, and the third support plate 213 all have a flat plate-like structure, so that the antennas 22 are easily fixed to the insulating support body 21. In other embodiments, alternatively, the first support plate 211, the second support plate 212, and the second support plate 212 may have an arc-shaped plate-like structure.

As shown in FIG. 2, the second support plate 212 and the third support plate 213 are both fixed to a same plate surface of the first support plate 211.

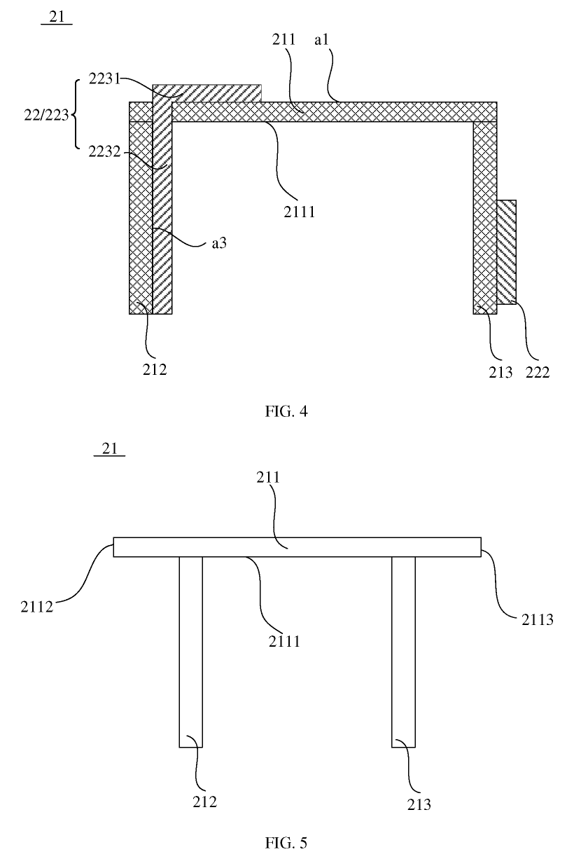

In an example, as shown in FIG. 2 and FIG. 3, the second support plate 212 and the third support plate 213 are fixed to two ends of a same plate surface 2111 of the first support plate 211. In this case, the insulating support body 21 may form an approximate "U"-shaped structure.

In another example, as shown in FIG. 5, the second support plate 212 and the third support plate 213 are fixed to a same plate surface 2111 of the first support plate 211, with a specific distance between the second support plate 212 and a first end 2112 of the plate surface 2111, and a specific distance between the third support plate 213 and a second end 2113 of the plate surface 2111.

As shown in FIG. 3 and FIG. 5, the insulating support body 21 formed by the first support plate 211, the second support plate 212, and the third support plate 213 may be a frame structure, so that the insulating support body 21 is stronger. A material of the insulating support body 21 may be an insulating material such as plastic.

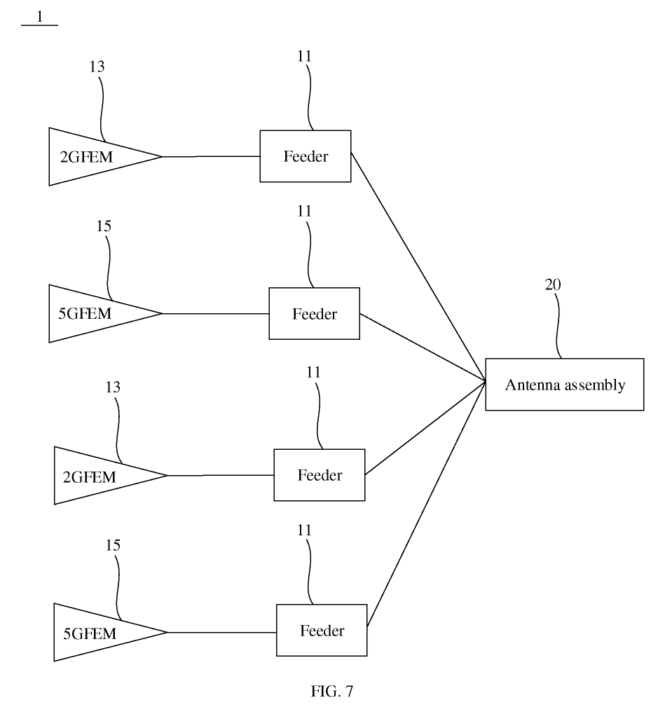

For the quantity of antennas 22, in a possible embodiment, as shown in FIG. 6, the antenna assembly 20 includes four antennas 22, namely, a first antenna 221, a second antenna 222, a third antenna 223, and a fourth antenna 224. The first antenna 221, the second antenna 222, the third antenna 223, and the fourth antenna 224 are each fixed to the insulating support body 21. In this way, the first antenna 221, the second antenna 222, the third antenna 223, and the fourth antenna 224 are relatively functionally independent, and each antenna 22 can provide one feed point for the antenna assembly 20. That is, the first antenna 221, the second antenna 222, the third antenna 223, and the fourth antenna 224 can provide four feed points for the antenna assembly 20. Then, the antenna assembly 20 in this embodiment has four feed points, so that the antenna assembly 20 can achieve a four-feed function.

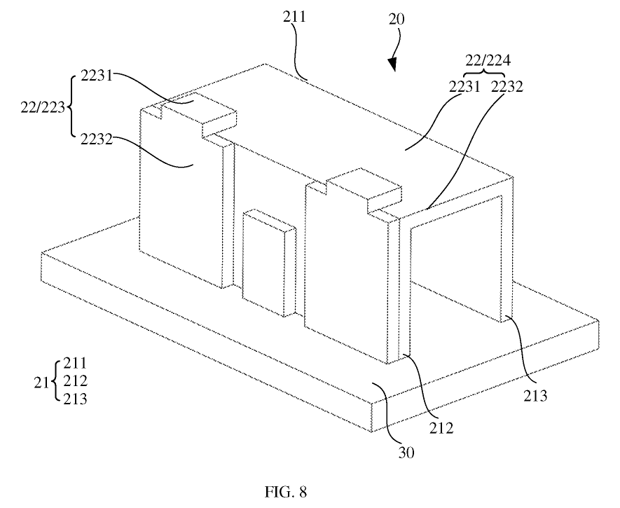

As shown in FIG. 7, when the antenna assembly 20 shown in FIG. 2 is used in the electronic device 1, because the antenna assembly 20 can provide four feed points, the two 2G FEMs 13 and the two 5G FEMs 14 can be connected to the antenna assembly 20 via feeders 11, respectively. Compared with the embodiment shown in FIG. 1, this embodiment requires no additional duplexers, thereby reducing costs of the electronic device 1.

In other embodiments, the antenna assembly 20 may include two antennas 22, and the antenna assembly 20 has two feed points. Alternatively, the antenna assembly 20 may include three antennas 22, and the antenna assembly 20 has three feed points. Alternatively, the antenna assembly 20 includes five antennas 22, and the antenna assembly 20 has five feed points. Certainly, the antenna assembly 20 may also include a larger number of antennas 22.

An example in which the antenna assembly 20 includes four antennas 22 is mainly used below for description.

For a quantity of operating bands of the antenna assembly 20, in this embodiment, the antenna assembly 20 may have two operating bands. That is, among the four antennas 22, a first part of the antennas 22 has a same operating band, and a second part of the antennas 22 has a same operating band, where the first part of the antennas 22 and the second part of the antennas 22 have different operating bands. In this way, the antenna assembly 20 can achieve a dual-band four-feed function. In other embodiments, the antenna assembly 20 may have three operating bands, four operating bands, or a larger number of operating bands.

The two operating bands may be two operating bands selected from an operating band of a 2G antenna, an operating band of a 3G antenna, an operating band of a 4G antenna, and an operating band of a 5G antenna.

For example, in a possible embodiment, an operating band of the first antenna 221 may be the same as an operating band of the second antenna 222, and an operating band of the third antenna 223 may be the same as an operating band of the fourth antenna 224, where the operating band of the third antenna 223 and the operating band of the fourth antenna 224 are both lower than the operating band of the first antenna 221 and the operating band of the second antenna 222. In an example, the first antenna 221 and the second antenna 222 are both 5G antennas, and the third antenna 223 and the fourth antenna 224 are both 2G antennas. In another example, the first antenna 221 and the second antenna 222 are both 2G antennas, and the third antenna 223 and the fourth antenna 224 are both 5G antennas.

In another possible embodiment, operating bands of the first antenna 221, the second antenna 222, and the third antenna 223 are the same, and operating bands of the fourth antenna 224 and the first antenna 221 are different. For example, the first antenna 221, the second antenna 222, and the third antenna 223 are all 5G antennas, and the fourth antenna 224 is a 2G antenna; or the first antenna 221, the second antenna 222, and the third antenna 223 are all 2G antennas, and the fourth antenna 224 is a 5G antenna.

As shown in FIG. 6, the first antenna 221 and the second antenna 222 may both have a plate-like structure. The first antenna 221 and the second antenna 222 may be spaced apart and fixed to the third support plate 213. This can increase a distance between the first antenna 221 and the second antenna 222, thereby improving antenna isolation.

Based on this, in a possible embodiment, polarization directions of the first antenna 221 and the second antenna 222 are different. For example, the first antenna 221 may be a vertically polarized antenna, and the second antenna 222 may be a horizontally polarized antenna. In this way, the antenna assembly 20 can achieve a dual-polarization function. In other words, the antenna assembly 20 in this embodiment of this application can achieve a dual-band four-feed dual-polarization function, thereby improving a throughput of the antenna assembly 20. It can be understood that, in this case, the first antenna 221 and the second antenna 222 have different structures.

In another possible embodiment, polarization directions of the first antenna 221 and the second antenna 222 are the same. In this case, the first antenna 221 and the second antenna 222 may have a same structure.

As shown in FIG. 2, in this embodiment, the third antenna 223 may have an "L"-shaped structure. For example, the third antenna 223 may include a first plate 2231 and a second plate 2232 connected to each other and forming an included angle. The first plate 2231 of the third antenna 223 is fixed to the first support plate 211, and the second plate 2232 of the third antenna 223 is fixed to the second support plate 212. In this way, the third antenna 223 is fixedly connected to the two support plates of the insulating support body 21, resulting in a stronger connection between the third antenna 223 and the insulating support body 21.

Further, in an example, as shown in FIG. 3, the first plate 2231 of the third antenna 223 is fixed to a surface a1 of the first support plate 211 that faces away from the second support plate 212, and the second plate 2232 of the third antenna 223 is fixed to a surface a2 of the second support plate 212 that faces away from the third support plate 213. Herein, an inner side and an outer side of the insulating support body 21 may be defined. An accommodation space 214 may be formed between the second support plate 212 and the third support plate 213 of the insulating support body 21. The accommodation space 214 may be on the inner side of the insulating support body 21, and a side opposite to the inner side is the outer side. In other words, the third antenna 223 is fixed to the outer side of the insulating support body 21.

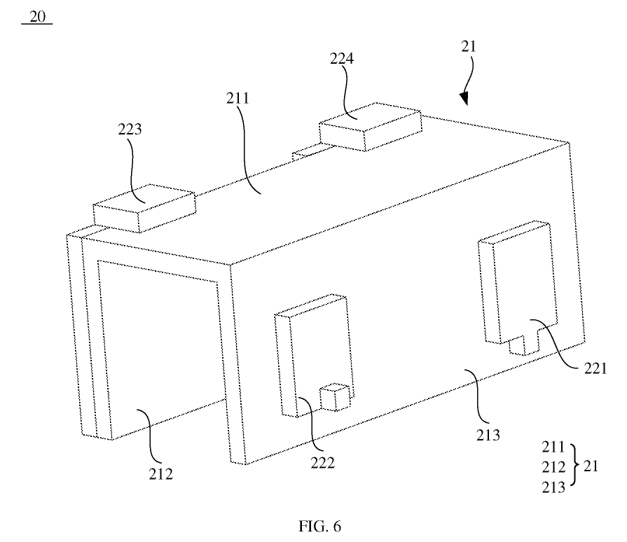

In another example, as shown in FIG. 4, a through hole is provided at a position on the first support plate 211 close to the second support plate 212. The first plate 2231 of the third antenna 223 may be fixed to a surface a1 of the first support plate 211 that faces away from the second support plate 212. One part of the second plate 2232 of the third antenna 223 may be located within the through hole, and the other part thereof extends beyond the through hole. In addition, the second plate 2232 is fixed to a surface a3 of the second support plate 212 that faces the third support plate 213. In this way, a part of the third antenna 223 is fixed to the second support plate 212 in an embedded manner, resulting in a stronger connection between the third antenna 223 and the second support plate 212, that is, a stronger connection between the third antenna 223 and the insulating support body 21.

A structure of the fourth antenna 224 may be the same as that of the third antenna 223. For example, as shown in FIG. 2, the fourth antenna 224 may also have an "L"-shaped structure. For example, the fourth antenna 224 may include a first plate 2231 and a second plate 2232 connected to each other and forming an included angle. The first plate 2231 of the fourth antenna 224 is fixed to the first support plate 211, and the second plate 2232 of the fourth antenna 224 is fixed to the second support plate 212. The fourth antenna 224 is also fixedly connected to the two support plates of the insulating support body 21, resulting in a stronger connection between the fourth antenna 224 and the insulating support body 21.

Further, as shown in FIG. 3, the first plate 2231 of the fourth antenna 224 is fixed to a surface a1 of the first support plate 211 that faces away from the second support plate 212, and the second plate 2232 of the fourth antenna 224 is fixed to a surface a2 of the second support plate 212 that faces away from the third support plate 213. In other words, the fourth antenna 224 is fixed to the outer side of the insulating support body 21. Alternatively, as shown in FIG. 4, the first plate 2231 of the fourth antenna 224 may be fixed to a surface a1 of the first support plate 211 that faces away from the second support plate 212. One part of the second plate 2232 of the fourth antenna 224 may be located within the through hole, and the other part thereof extends beyond the through hole. In addition, the second plate 2232 of the fourth antenna 224 is fixed to a surface a3 of the second support plate 212 that faces the third support plate 213. In this way, a part of the fourth antenna 224 is fixed to the second support plate 212 in an embedded manner, resulting in a stronger connection between the fourth antenna 224 and the second support plate 212, that is, a stronger connection between the fourth antenna 224 and the insulating support body 21.

In addition, as shown in FIG. 2, an end that is of the second plate 2232 of the third antenna 223 and that faces away from the first plate 2231 is flush with an end of the second support plate 212 that faces away from the first support plate 211. In addition, an end that is of the second plate 2232 of the fourth antenna 224 and that faces away from the first plate 2231 is flush with an end of the second support plate 212 that faces away from the first support plate 211.

It can be understood that, in this embodiment, as shown in FIG. 2, the third antenna 223 and the fourth antenna 224 may both have an "L"-shaped structure. In other embodiments, alternatively, the third antenna 223 and the fourth antenna 224 may have a plate-like structure.

As shown in FIG. 2, the antenna assembly 20 may further include a decoupling portion 23. The decoupling portion 23 is fixed to the insulating support body 21, and is located between the third antenna 223 and the fourth antenna 224. For example, in this embodiment, the decoupling portion 23 is fixed to the second support plate 212. In other embodiments, the decoupling portion 23 may be fixed to the first support plate 211. In this way, the decoupling portion 23 can reduce coupling between a signal of the third antenna 223 and a signal of the fourth antenna 224, thereby further improving antenna isolation.

The antenna assembly 20 according to this embodiment of this application may be manufactured by using the following two methods:

In a first method, the antennas 22 may be first manufactured by stamping molding, machining, and the like. The antennas 22 are placed inside a mold, and injection molding is performed within the mold to form the insulating support body 21, thereby producing the antenna assembly 20. The insulating support body 21 may be made of an insulating material such as plastic, and the antennas 22 are connected to the insulating support body 21 once injection molding is completed. Because the third antenna 223 and the fourth antenna 224 are both fixed to the outer side of the insulating support body 21, during the placement of the third antenna 223 and the fourth antenna 224 inside the mold before injection molding, the third antenna 223 and the fourth antenna 224 may both be attached closely to the inner wall of the mold for placement, so that the third antenna 223 and the fourth antenna 224 can be conveniently secured in the mold.

In a second method, the insulating support body 21 may be first manufactured by injection molding. Areas on the insulating support body 21 in which the antennas 22 are disposed are metallized to form the antennas 22, thereby producing the antenna assembly 20. When the third antenna 223 and the fourth antenna 224 are both fixed to the outer side of the insulating support body 21, it is convenient to manufacture the third antenna 223 and the fourth antenna 224 through metallization.

In addition, in this embodiment, the antennas 22 and the insulating support body 21 are manufactured by using different materials and different processes. Therefore, during the manufacture of each antenna 22, the antenna 22 may be manufactured as an antenna 22 having a specific decoupling function and filtering function. In this way, an integration level of the antenna assembly 20 is improved, and as shown in FIG. 7, the filters 12 in the embodiment shown in FIG. 1 can be omitted, thereby further reducing costs of the electronic device 1. In addition, coupling between a signal of the first antenna 221 and a signal of the second antenna 222 can be reduced, and coupling between the signal of the first antenna 221 and a signal of the fourth antenna 224 and between the signal of the second antenna 222 and the signal of the fourth antenna 224 can be reduced, thereby improving antenna isolation.

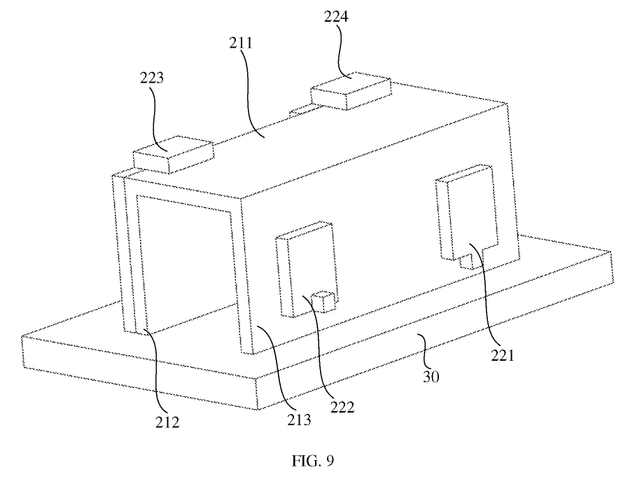

The electronic device 1 usually includes a circuit board 30. As shown in FIG. 8 and FIG. 9, the antenna assembly 20 may be fixed to the circuit board 30. For example, the second support plate 212 and the third support plate 213 may be bonded to the circuit board 30, to achieve a fixed connection between the antenna assembly 20 and the circuit board 30. Alternatively, the third antenna 223 and the fourth antenna 224 may be welded to the circuit board 30, to achieve a fixed connection between the antenna assembly 20 and the circuit board 30.

In other embodiments of this application, a difference from the embodiment shown in FIG. 2 lies in that the structure of the insulating support body 21, the structure of the third antenna 223, and the structure of the fourth antenna 224 are different, and that this embodiment omits the decoupling portion 23 that is present in the embodiment shown in FIG. 2.

In this embodiment, the insulating support body 21 includes a first support plate 211 and a second support plate 212 fixed to the first support plate 211, and there is an included angle between the second support plate 212 and the first support plate 211.

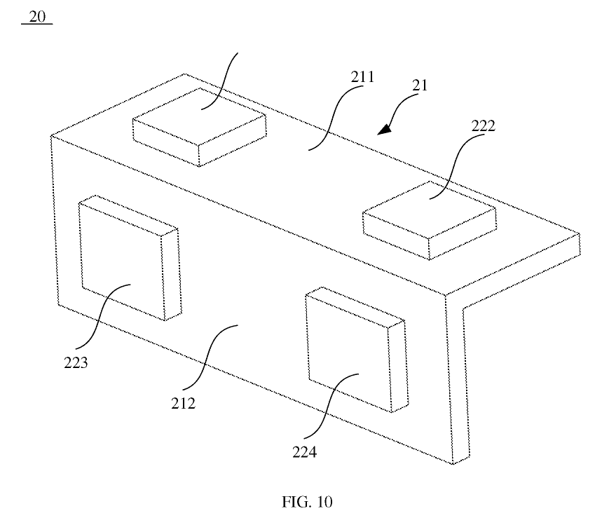

In an example, as shown in FIG. 10, an end portion of the second support plate 212 is fixedly connected to an end portion of the first support plate 211. In this way, the insulating support body 21 may form an "L"-shaped structure.

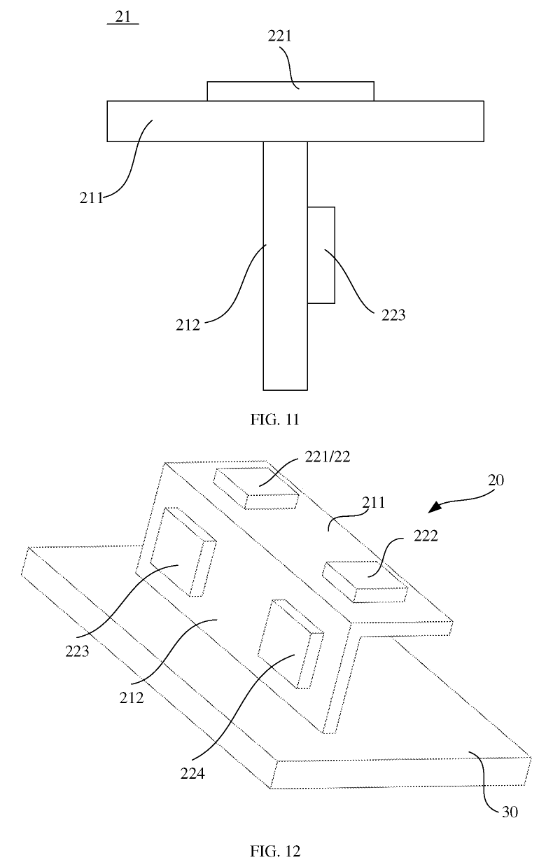

In another example, as shown in FIG. 11, the second support plate 212 is fixed to the middle of the first support plate 211. In this way, the insulating support body 21 may form a "T"-shaped structure. Compared with the flat plate-like insulating support body 21, the insulating support body 21 in this embodiment is stronger.

As shown in FIG. 10, one part of the antennas 22 is fixed to the first support plate 211, and the other part of the antennas 22 is fixed to the second support plate 212. For example, the first antenna 221, the second antenna 222, the third antenna 223, and the fourth antenna 224 may all have a plate-like structure. As shown in FIG. 10, in this embodiment, the first antenna 221 and the second antenna 222 are fixed to the first support plate 211, and the third antenna 223 and the fourth antenna 224 are fixed to the second support plate 212. In other embodiments, the first antenna 221 and the third antenna 223 may be fixed to the first support plate 211, and the second antenna 222 and the fourth antenna 224 may be fixed to the second support plate 212. In this way, a smaller number of antennas 22 are fixed to each of the first support plate 211 and the second support plate 212, so that a distance between the antennas 22 fixed to a same support plate can be increased, and signal interference between the antennas 22 fixed to the same support plate can be reduced, thereby improving antenna isolation.

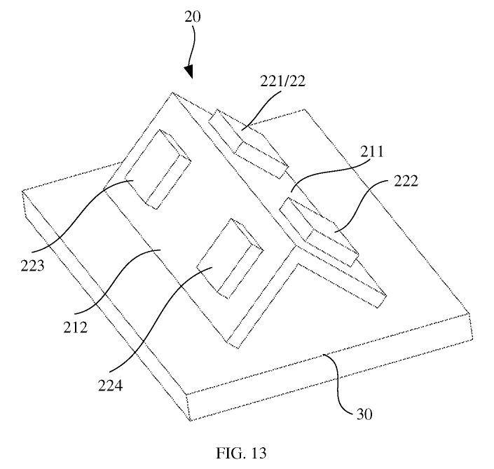

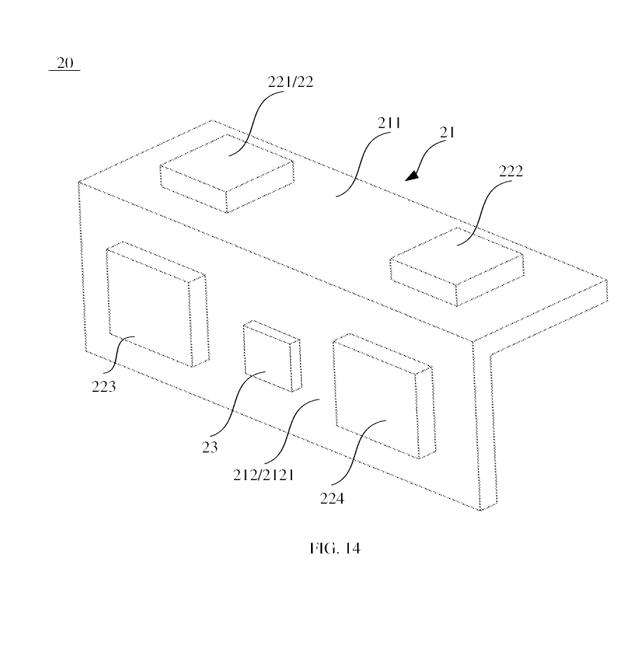

The electronic device 1 usually includes a circuit board 30. As shown in FIG. 12 and FIG. 13, the antenna assembly 20 may be fixed to the circuit board 30. In an example, as shown in FIG. 12, the second support plate 212 of the insulating support body 21 is fixed to the circuit board 30, and there is a spacing between the first support plate 211 and the circuit board 30. In another example, as shown in FIG. 13, the first support plate 211 and the second support plate 212 are both in contact with and fixed to the circuit board 30.

In other embodiments of this application, a difference from the embodiment shown in FIG. 10 lies in that this embodiment adds the decoupling portion 23 that is absent in the embodiment shown in FIG. 10. As shown in FIG. 14, the second support plate 212 includes a first surface 2121. The third antenna 223, the decoupling portion 23, and the fourth antenna 224 are spaced apart and fixed to the first surface 2121. In this way, there is a spacing between the third antenna 223 and the decoupling portion 23, and there is a spacing between the decoupling portion 23 and the fourth antenna 224, so that a decoupling effect of the decoupling portion 23 between the third antenna 223 and the fourth antenna 224 can be further improved.

The foregoing describes embodiments of this application with reference to the accompanying drawings. However, this application is not limited to the foregoing specific embodiments. The foregoing specific embodiments are merely non-limiting examples. In light of the teachings of this application, a person of ordinary skill in the art may further make many modifications without departing from the purposes of this application and the protection scope of the claims, and all the modifications shall fall within the protection of this application.

1. An antenna assembly, comprising:
an insulating support body; and
at least two antennas, wherein the at least two antennas are each fixed to the insulating support body, and a gap is provided between any two antennas.

2. The antenna assembly according to claim 1, wherein the at least two antennas comprise a first antenna, a second antenna, a third antenna, and a fourth antenna, and the first antenna, the second antenna, the third antenna, and the fourth antenna provide four feed points for the antenna assembly.

3. The antenna assembly according to claim 2, wherein an operating band of the first antenna is the same as an operating band of the second antenna, and polarization directions of the first antenna and the second antenna are different.

4. The antenna assembly according to claim 2, wherein an operating band of the third antenna is the same as an operating band of the fourth antenna, and both are lower than the operating bands of the first antenna and the second antenna.

5. The antenna assembly according to claim 2, further comprising a decoupling portion, wherein the decoupling portion is fixed to the insulating support body, and the decoupling portion is located between the third antenna and the fourth antenna.

6. The antenna assembly according to claim 2, wherein the insulating support body comprises a first support plate and a second support plate fixed to the first support plate, and there is an included angle between the second support plate and the first support plate.

7. The antenna assembly according to claim 6, wherein one part of the at least two antennas is fixed to the first support plate, and the other part of the antennas is fixed to the second support plate.

8. The antenna assembly according to claim 6, wherein the insulating support body further comprises a third support plate fixed to the first support plate, and the third support plate and the second support plate are disposed opposite to each other.

9. The antenna assembly according to claim 6, further comprising a decoupling portion, wherein the second support plate comprises a first surface, and the third antenna, the decoupling portion, and the fourth antenna are spaced apart and fixed to the first surface.

10. The antenna assembly according to claim 8, further comprising a decoupling portion, wherein the third antenna and the fourth antenna each comprise a first plate and a second plate connected to each other and forming an included angle; and
the respective first plates of the third antenna and the fourth antenna are both fixed to the first support plate, the respective second plates of the third antenna and the fourth antenna are both fixed to the second support plate, and the decoupling portion is fixed to the first support plate or the second support plate.

11. The antenna assembly according to claim 10, wherein an end of the first support plate that is close to the second support plate is provided with a through hole, and the first plate is fixed to a surface of the first support plate that faces away from the second support plate; and
one part of the second plate is located within the through hole, and the other part of the second plate extends beyond the through hole, and the second plate is fixed to a surface of the second support plate that faces the third support plate.

12. The antenna assembly according to claim 10, wherein the first plate is fixed to a surface of the first support plate that faces away from the second support plate, and the second plate is fixed to a surface of the second support plate that faces away from the third support plate.

13. An electronic device, comprising a circuit board and an antenna assembly, wherein the antenna assembly is fixed to the circuit board;
wherein the antenna assembly comprising:
an insulating support body; and
at least two antennas, wherein the at least two antennas are each fixed to the insulating support body, and a gap is provided between any two antennas.

14. The electronic device according to claim 13, wherein the at least two antennas comprise a first antenna, a second antenna, a third antenna, and a fourth antenna, and the first antenna, the second antenna, the third antenna, and the fourth antenna provide four feed points for the antenna assembly.

15. The electronic device according to claim 14, wherein an operating band of the first antenna is the same as an operating band of the second antenna, and polarization directions of the first antenna and the second antenna are different.

16. The electronic device according to claim 14, wherein an operating band of the third antenna is the same as an operating band of the fourth antenna, and both are lower than the operating bands of the first antenna and the second antenna.

17. The electronic device according to claim 14, further comprising a decoupling portion, wherein the decoupling portion is fixed to the insulating support body, and the decoupling portion is located between the third antenna and the fourth antenna.

18. The electronic device according to claim 14, wherein the insulating support body comprises a first support plate and a second support plate fixed to the first support plate, and there is an included angle between the second support plate and the first support plate.

19. The electronic device according to claim 18, wherein one part of the at least two antennas is fixed to the first support plate, and the other part of the antennas is fixed to the second support plate.

20. The electronic device according to claim 18, wherein the insulating support body further comprises a third support plate fixed to the first support plate, and the third support plate and the second support plate are disposed opposite to each other.
